(19) United States
(12) Patent Application Publication
(10) Pub. No.: US 2010/0259656 A1
(43) Pub. Date: Oct. 14, 2010

(54) Apparatus For Fluorescence Diagnosis

(76) Inventors: Klaus-Martin Irion, Emmingen-Liptingen (DE); Andre Ehrhardt, Wurmlingen (DE); Peter Solleder, Konstanz (DE)

Correspondence Address: ST. ONGE STEWARD JOHNSTON & REENS, LLC, 986 BEDFORD STREET, STAMFORD, CT, 06905-5619, US

(21) Appl. No.: 12/756,567

(22) Filed: Apr. 8, 2010

(30) Foreign Application Priority Data
Apr. 8, 2009 (DE) 10 2009 018 142.3

(51) Int. Cl. H04N 5/335; G02B 21/06

(52) U.S. Cl. 348/273; 359/385; 359/388; 348/E05.091

(57) ABSTRACT

An apparatus for fluorescence diagnosis comprises an illumination system for illuminating a target area. The observation system has an observation instrument and a camera. The illumination system can be switched between at least two illumination modes. The observation system has an optical arrangement having at least one optical element that selectively can be introduced into the observation beam path or can be removed therefrom in order to switch the optical properties of the observation system between at least two observation modes. The optical arrangement of the observation system has a motor drive for introducing the at least one optical element into the observation beam path and for removing said element therefrom, and there is a control unit which is connected to the illumination system and to the observation system and which controls the motor drive as a function of the set illumination mode of the illumination system.

### CROSS-REFERENCE TO FOREIGN APPLICATION

The present application claims priority of German patent application No. 10 2009 018 142.3 filed on Apr. 8, 2009.

### BACKGROUND OF THE INVENTION

The invention generally relates to apparatuses for fluorescence diagnosis. More specifically, the invention relates to an apparatus for fluorescence diagnosis, comprising an illumination system for illuminating a target area and an observation system for observing the target area, wherein the illumination system can be switched between at least two illumination modes.

An apparatus according to the invention for fluorescence diagnosis of the type mentioned at the outset can be used for medical diagnostic purposes, but also for technical diagnostic purposes in industrial or scientific applications. Although hereafter the invention will be described with reference to the medical fluorescence diagnosis, the invention is not limited thereto.

The medical fluorescence diagnosis is used for evaluating the state of biological tissue, in particular for detecting a tumour. An apparatus for fluorescence diagnosis of the type mentioned at the outset in particular can carry out the fluorescence diagnosis in vivo.

In the medical fluorescence diagnosis, a patient is administered a photosensitizer in advance, or the latter is introduced into the target area to be observed, for example a tissue region intended to be examined for the presence of malignant tissue, wherein a precursor of the photosensitizer also can be administered or introduced in place thereof. Irradiation with light in a spectral range absorbed by the photosensitizer can excite the photosensitizer to fluoresce. The illumination system of the apparatus for fluorescence diagnosis correspondingly has at least one illumination mode in which the illumination system supplies light in a spectral range suitable for exciting the fluorescence to the target area. The fluorescence light of the photosensitizer excited thus is then supplied to the camera via the observation instrument, wherein the fluorescence image recorded by the camera can be displayed visually on a monitor.

Since the intensity of the fluorescence is significantly lower than the intensity of the fluorescence-excitation light, the observation system has an observation mode in which an optical element, usually a spectral filter, is introduced into the observation beam path, which optical element basically only transmits the longer wavelength fluorescence light, while the more intensive shorter wavelength fluorescence-excitation light is basically not transmitted, or at least weakened to the extent that a contrast-rich fluorescence image can be observed.

The above-described illumination mode of the illumination system and the associated observation mode of the observation system are usually referred to as the “fluorescence mode”; this is also the case in the subsequent description.

However, currently available apparatuses for fluorescence diagnosis can be operated not only in a single fluorescence mode, but also in a plurality of, for example two, fluorescence modes. Thus, a fluorescence diagnosis can be carried out not only on the basis of the fluorescence of a photosensitizer but also on the basis of the fluorescence of the tissue itself, the so-called autofluorescence. Since the spectral range of the fluorescence-excitation light and the spectral range of the fluorescence light in the case of autofluorescence differ from the spectral range of the fluorescence-excitation spectrum and the spectral range of the fluorescence light of a photosensitizer, known apparatuses for fluorescence diagnosis are designed such that the illumination system can be switched between at least two illumination modes, to be precise between a first illumination mode for fluorescence diagnosis by means of a photosensitizer and a second illumination mode for the autofluorescence diagnosis.

Accordingly, the observation system of such apparatuses for fluorescence diagnosis also has at least two observation modes, to be precise a first observation mode for fluorescence diagnosis by means of a photosensitizer and an observation mode for the autofluorescence. The optical arrangement of the observation system has, for this case, at least two optical elements; for example, two spectral filters with different transmission characteristics, which are matched to the respective fluorescence spectrum of the photosensitizer and the tissue-own fluorescence spectrum thereof.

Hence, within the scope of the present invention, the at least two illumination modes and the at least two observation modes can be two different fluorescence modes.

However, the present invention is not limited to the case described above. The diagnosing medical practitioner, e.g. for reasons of better orientation in the target area, i.e. in an observed tissue region, may wish to be able to observe the target area in usual white-light illumination as well. Currently known apparatuses for fluorescence diagnosis therefore also have an illumination mode of the illumination system in which the illumination system illuminates the target area with white light, i.e. light with the entire visible spectral range. Correspondingly, this illumination mode is associated with an observation mode of the observation system, by means of which an image of the target area can be observed which is as true to its natural colours as possible. For this, a spectral filter previously introduced into the observation beam path for the fluorescence mode is again removed from the observation beam path. This illumination and observation mode is usually referred to as a white-light mode; this is also the case in the following description.

Therefore, within the scope of the present invention, the at least two illumination modes and the at least two observation modes also can comprise a single fluorescence mode and a white-light mode. However, more than two illumination and observation modes also can be provided within the scope of the present invention, for example two different fluorescence modes and one white-light mode.

Whereas the known apparatuses for fluorescence diagnosis allow a switch between the at least two illumination modes using operating elements situated on the camera as a result of electronic coupling of the camera with the illumination system, the associated observation modes must be switched by hand, i.e. the at least one optical element of the observation system, e.g. a spectral filter, is manually introduced into the observation beam path and manually removed therefrom in the known apparatuses. In the known apparatuses for fluorescence diagnosis, the corresponding optical arrangement of the observation system with the at least one optical element which can be introduced and removed is integrated in the observation instrument, e.g. an endoscope.

DE 197 13 276 C2 discloses such an endoscope, in which the position of an optical arrangement with a plurality of optical elements for switching between different observation modes made possible by the endoscope can be adjusted by a set collar operable by hand, wherein the set collar for adjusting the position of the optical arrangement interacts with the optical arrangement via a magnetic coupling.

However, manual switching between the observation modes of the observation system has disadvantages. The manual switching between different observation modes of the observation system does not always ensure that the manually set observation mode also fits the current illumination mode of the illumination system because the user has mistakenly introduced an optical element not matched to the current illumination mode into the observation beam path. Thus, known apparatuses for fluorescence diagnosis have the problem of erroneous operations. Moreover, performing the fluorescence diagnosis takes a lot of time and is cumbersome due to the manual switch between the observation modes.

### SUMMARY OF THE INVENTION

The invention is based on an object of developing an apparatus for fluorescence diagnosis such that the operation thereof is simplified and less timeconsuming and erroneous operations are excluded as far as possible.

According to the invention, an apparatus for fluorescence diagnosis is provided, comprising
an illumination system for illuminating a target area, the illumination system being switchable between at least two illumination modes,
an observation system for observing the target area, the observation system having
an observation instrument,
a camera,
an optical arrangement having at least one optical element that selectively can be introduced into an observation beam path or can be removed from the observation beam path in order to switch optical properties of the observation system between at least two observation modes,
the optical arrangement having a motor drive for introducing the at least one optical element into the observation beam path or for removing the element from the observation beam path,
a control unit connected to the illumination system and to the observation system, the control unit controlling the motor drive as a function of a set illumination mode of the illumination system.

The apparatus according to the invention for fluorescence diagnosis allows not only a simple operation of the switch between the at least two observation modes, but also that said switch between the at least two observation modes of the observation system is brought about automatically as a function of the respectively set illumination mode of the illumination system, without the user manually having to match the respective observation mode to the respectively current illumination mode. For this, the optical arrangement of the observation system is provided with a motor drive, for example an electric-motor drive, which is controlled by the control unit as a function of the set illumination mode of the illumination system. If the user of the apparatus according to the invention sets a certain operating mode of the apparatus, for example via an operating button on the camera, the control unit automatically sets the corresponding illumination mode and the associated observation mode. For example, if the user switches from the white-light mode to the fluorescence mode, the control unit controls the motor drive of the optical arrangement of the observation system in order to introduce the at least one optical element, for example a spectral filter suitable for the fluorescence mode, into the observation beam path. When a switch is made into the white-light mode, the optical element again is removed automatically from the observation beam path. It is significantly easier to operate the apparatus according to the invention for fluorescence diagnosis than the known apparatuses for fluorescence diagnosis, and erroneous operations are eliminated, i.e. it cannot happen that an observation mode that does not fit the current illumination mode is set.

The apparatus according to the invention preferably comprises an endoscope or an operation microscope.

The motor drive can be an electric-motor drive, wherein other types of drives are well suited, like magnetic, hydraulic, piezoelectric and electromagnetic drives.

The control unit preferably also controls the camera system as a function of the illumination mode in order to set the corresponding colour mode in the camera.

In a preferred refinement, the control unit controls the motor drive synchronously with the change in the illumination mode of the illumination system.

The advantage of this measure consists of the fact that the observation modes are switched at the same time as the illumination modes are switched and hence the camera always correctly receives the image of the target area corresponding to the set illumination mode. The control unit also preferably controls the appropriate colour mode of the camera system synchronously with the change in the illumination mode.

In another preferred refinement, the optical arrangement of the observation system is arranged in the camera.

Herein, it is now advantageous that the integration of the motor drive into the camera is significantly less complicated than the integration of the motor drive into the observation instrument. The observation instrument, for example an endoscope or an operation microscope, is usually an instrument without power. If a motor-driven optical arrangement is integrated into the observation instrument, particularly an endoscope, the fact that the autoclavability of such an observation instrument introduced into the body of a patient must be ensured has to be taken into account. However, if an endoscope contains a motor drive, electrical contacts, for example, are required for supplying and controlling the motor drive, but said contacts cannot withstand the thermal loads of a steam sterilization in an autoclave. By contrast, the integration of a motor drive into the camera is significantly more cost-effective and easier to implement since the camera does not always have to be sterilized in an autoclave. In some medical applications, it suffices for the camera to be kept sufficiently sterile as a result of a sterile overcoat since the camera is always used outside of the body. Moreover, a further advantage of this measure is that a plurality of observation instruments e.g. endoscopes with different viewing directions can be used with the same camera, and thus the motor-driven optical arrangement only has to be provided once, namely in the camera.

In this context, it is preferred if the optical arrangement is arranged in the region of an objective system of the camera.

The optical arrangement with the motor drive can be integrated particularly advantageously in the region of the objective system of the camera; in particular, this region is also easily accessible for replacing the optical arrangement.

In the case of the at least two observation modes comprising at least one fluorescence mode, the at least one optical element is a spectral filter. The spectral filter is introduced into the observation beam path or removed therefrom again by the motor drive in order to switch between the fluorescence mode and e.g. a white-light mode or another fluorescence mode.

In another preferred refinement, which is preferred in particular in conjunction with the aforementioned refinement, the optical arrangement is arranged substantially in the parallel beam path of the observation system.

This measure is advantageous because spectral filters in the form of interference filters in particular change their spectral transmission properties in the non-parallel beam path in respect of their specification.

In another preferred refinement, the control unit sets camera parameters of the camera as a function of the illumination mode and/or the observation mode.

Herein it is advantageous that it is not only the observation modes and the illumination modes that are mutually synchronized by the control unit, but also that the camera parameters are synchronously matched to the respective observation mode and illumination mode. Such camera parameters can be, for example, white-light balancing in the white-light mode, the integration time(s) of the image recorder(s) of the camera in the case of an electronic camera, the electronic amplification of the video signal in the case of an electronic camera, brightness controls of the camera image, particular colour settings for the corresponding colour mode of the camera, etc.

In another preferred refinement, the control unit is connected to the observation system and the illumination system via a communication system, which is selected from the group having a field bus, Ethernet, Bluetooth, WLAN, USB or the like.

The aforementioned communication systems are suitable in a particularly advantageous fashion for the apparatus according to the invention for fluorescence diagnosis because they are also suitable for the control unit or a master to be able to recognize the attached systems (observation system, illumination system, camera) and in particular the operating states thereof.

In another preferred refinement, the optical arrangement of the observation system has a motor-driven optical system changer, which has the at least one optical element.

The optical system changer is preferably designed as a wheel that can be rotated about an axis parallel to the optical axis.

The refinement of the optical arrangement with a motor-driven optical system changer, which is preferably designed as a wheel, allows an advantageously compact design of the optical arrangement of the observation system, which is suitable for integration into the camera of the observation system. For this, the wheel does not have to have either a circular design or a complete circumference.

As already mentioned above, the at least two operating modes of the illumination system preferably comprise a white-light mode and at least one fluorescence-excitation mode.

Advantageously, the apparatus according to the invention is particularly suitable for a refinement in which the illumination system comprises, in addition to the white-light mode, a first fluorescence-excitation mode, in which the spectral property of the illumination system is matched to a photosensitizer, and a fluorescence-excitation mode, in which the spectral property of the illumination system is matched to the autofluorescence. However, provision also can be made by all means for further illumination modes of the illumination system, wherein the present invention is particularly advantageous if the illumination system can be switched between more than two operating modes because the disadvantages of manual switching of the observation modes increase in such a case and, conversely, the advantages of the automatic switching of the observation modes synchronized with the switching of the illumination modes increase.

In another preferred refinement, the changer has a plurality of optical elements, which preferably have a plurality of spectral filters for a plurality of spectral ranges.

This refinement is advantageous in particular if the illumination system has more than two illumination modes, in particular at least two fluorescence modes.

The introduction or removal of the optical elements of the optical arrangement of the observation system preferably is brought about in each case synchronously with the set illumination mode of the illumination system and the corresponding colour mode of the camera system in an automatic fashion without manual intervention by the user.

In another preferred refinement, the illumination system has a second optical arrangement having at least one optical element that selectively can be introduced into the illumination beam path and can be removed therefrom in order to switch between the at least two illumination modes.

The advantage of this refinement is that the illumination system can have a white-light source as a light source, while the different optical properties, for example the spectral characteristics of the illumination system, between which it is possible to switch in the various illumination modes, are implemented by moveable optical elements, for example by spectral filters. Although it is also possible within the scope of the invention for the different illumination modes of the illumination system to be implemented by a plurality of light sources, for example with different emission characteristics, the aforementioned refinement however has the advantage of being less complex and therefore more cost-effective, and moreover of being modifiable more easily.

In another preferred refinement, the optical arrangement of the observation system and/or the second optical arrangement of the illumination system have or has a sensor, in particular a position sensor, that detects the current configuration of the optical arrangement of the observation system and/or the current configuration of the second optical arrangement of the illumination system.

Herein, it is advantageous that detecting the current configuration of the optical arrangement of the observation system and/or the illumination system ensures the synchronicity and correct matching of the respectively set observation mode to the respectively set illumination mode with a high functional reliability.

Further advantages and features emerge from the following description and the attached drawing.

It is understood that the aforementioned features and advantages, and the features and advantages still to be explained below can be used not only in the respectively specified combination, but also in other combinations or on their own, without departing from the scope of the present invention.

### BRIEF DESCRIPTION OF THE DRAWINGS

An exemplary embodiment is illustrated in the drawing and described in more detail below with reference thereto, in which:

FIG. 1 shows a block diagram of an apparatus for fluorescence diagnosis; and

FIG. 2 shows, on its own, an optical arrangement of an observation system of the apparatus for fluorescence diagnosis as per FIG. 1, with an enlarged scale compared to FIG. 1 and in a view along the direction of the optical axis of the optical arrangement.

### DETAILED DESCRIPTION OF AN EXEMPLARY PREFERRED EMBODIMENT

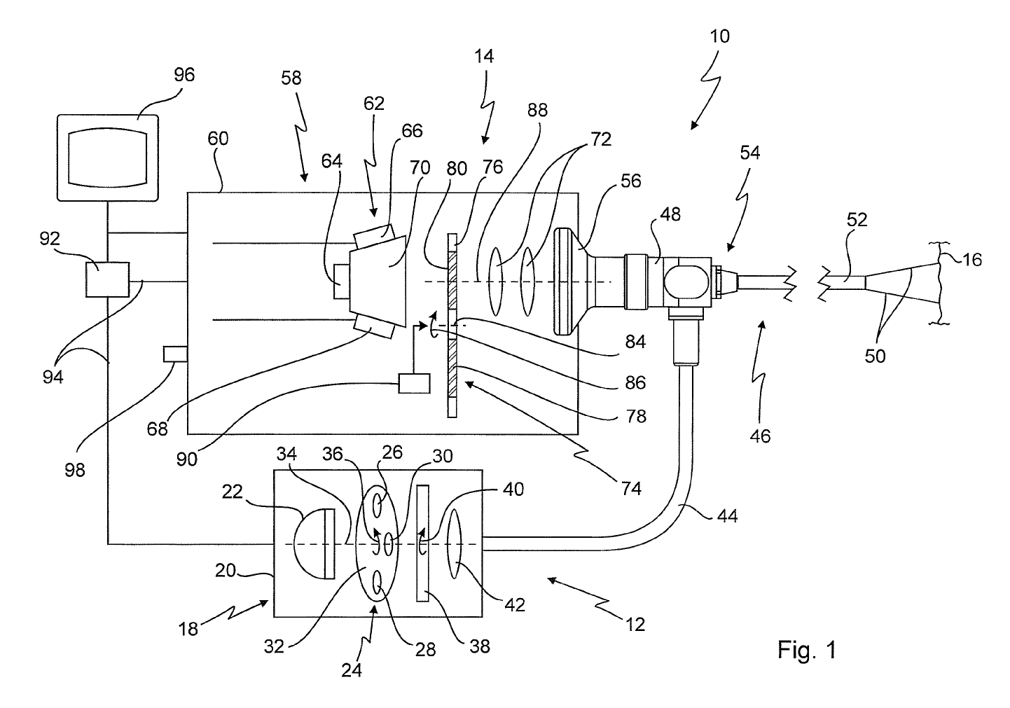

FIG. 1 illustrates a block diagram of an apparatus for fluorescence diagnosis provided with the general reference sign 10. Without loss of generality, the apparatus 10 will be described in the following text on the basis of a use for medical fluorescence diagnosis. However, the apparatus 10 can also be used for technical fluorescence diagnosis for industrial or scientific purposes.

In general, the apparatus 10 has an illumination system 12 and an observation system 14.

The illumination system 12 is used for illuminating a target area 16, which can be a tissue region in the human or animal body, and the observation system 14 is used to observe the target area 16.

The illumination system 12 has a light source 18. A lamp 22 or a lamp system, for example a xenon discharge lamp, is arranged in a housing 20 of the light source 18. However, other lamps or lamp systems generating white light can also be used, such as arc discharge lamps, incandescent lamps, LED lamp systems, laser systems, laser diode systems and the like.

The light source 18 furthermore has an optical arrangement 24 that has at least one optical element (in this case, it has three optical elements 26, 28 and 30). At least two of the optical elements 26, 28 and 30 are designed as spectral filters, wherein the two spectral filters have differing transmission characteristics. By way of example, the optical element 30 is designed as a light through-hole, which does not change the properties of the light, in particular the spectrum of the light emitted by the lamp 22.

The optical arrangement 24 of the illumination system 12 has an optical system changer 32, on which the optical elements 26, 28 and 30 are arranged. FIG. 1 shows that the optical system changer 32 is designed as a wheel, which can rotate about an axis 34 in accordance with an arrow 36. The optical system changer 32 is driven by preferably an electric-motor drive (not illustrated). The electric-motor drive rotates the optical system changer 32 such that respectively one of the optical elements 26, 28, 30 is situated in the beam path of the light emitted by the lamp 22. Instead of an electric-motor drive, magnetic, pneumatic, hydraulic, piezoelectric and electromagnetic drives can be used.

If one of the optical elements 26, 28 designed as a filter is brought into the illumination beam path of the light emitted by the lamp 22, the illumination system 12 is in each case in a fluorescence mode, wherein the illumination system 12 has a total of two fluorescence modes with different spectral properties of the illumination light in the illustrated exemplary embodiment. By way of example, a first fluorescence mode can be such a mode in which fluorescence-excitation light is radiated into the target area 16 in order to excite a photosensitizer located there to fluoresce, the excitation light being produced by the light emitted by the lamp 22 after passing through the optical element 26. A second fluorescence mode, which is set by the optical element 28 being brought into the illumination beam path of the light emitted by the lamp 22 instead of the optical element 26, can be used, for example, to excite tissue in the target area 16 to autofluoresce. White light is radiated into the target area 16 in a third illumination mode (white-light mode), which is present if the optical element 30, designed as a light through-hole for the light emitted by the lamp 22, is arranged in the illumination beam path instead of the optical elements 26 and 28.

A light attenuator 38 is arranged downstream of the optical arrangement 24 in the light propagation direction, which attenuator selectively can be pivoted into the illumination beam path and can be pivoted thereout again, or which, as indicated by an arrow 40, can rotate and has a plurality of regions with different light attenuation in order to dim the illumination light.

Finally, the light source 18 furthermore has a condenser optical system 42, which bundles the light emitted by the lamp 22 such that said light is coupled into a light conducting cable 44 connecting the light source 18 with a light-supplying instrument 46. The light conducting cable 44, which for example contains an incoherent optical-fibre bundle therein, radiates the illumination light emanating from the light source 18 into the light-supplying instrument 46, designed in this case as an endoscope 48 with an integrated waveguide, and into the target area 16 (light bundle 50). The endoscope 48 acting as a light-supplying instrument 46 has an elongate shaft 52, which is inserted into the body of a patient into the vicinity of the target area 16.

The observation system 14, which can be used to observe the target area 16, has an observation instrument 54 that, like the light-supplying instrument 46, is formed by the endoscope 48.

It is understood that the light-supplying instrument 46 and the observation instrument 54 also can be implemented by a microscope, a comparable instrument or else by separate instruments instead of by an endoscope. The endoscope 48 can be of any usual design, wherein the endoscope 48 in the present exemplary embodiment is an endoscope with an eyepiece 56 at the proximal end of the endoscope 48.

A camera 58 is attached to the endoscope 48, more precisely to the eyepiece 56, as a further component of the observation system 14.

An image-recorder unit 62 is arranged in a housing 60 of the camera 58 and it has three image recorders, for example CCD (charge-coupled apparatus) chips. The three image recorders 64, 66, 68 are sensitive in different spectral ranges image recorder 64 in e.g. the blue spectral range, image recorder 66 in e.g. the red spectral range and image recorder 68 in e.g. the green spectral range. Using a camera with three image recorders sensitive in different spectral ranges is advantageous in that there is improved separation of the colour channels. An example of such a camera with three image recorders is distributed by the company Karl Storz GmbH & Co. KG, Tuttlingen, Germany, under the trade mark of Tricam® SL-PDD.

By way of example, the image recorder 64 detects fluorescence-excitation light of the illumination system 12 back-scattered from the target area 16, the image recorder chip 66 detects fluorescence light from the target area 16 and the image recorder chip 68 detects autofluorescent light from the target area 16. In the white-light mode, natural coloured light transmitted by the endoscope 48 from the target area 16 is detected by all three image recorder chips 64, 66, 68.

Moreover, the camera 58 can also have a fourth image recorder (not illustrated) which is specifically sensitive in the infrared spectral range and so, depending on the used photosensitizer, fluorescent light also can be recorded in the infrared spectral range by the camera 58 and visualized on a monitor, e.g. in the form of a false-colour display (because infrared information is invisible).

Additionally, the image-recorder unit 62 has a prism 70, which distributes the image transmitted by the endoscope 48 onto the image recorders 64, 66, 68.

Downstream of the eyepiece 56 of the endoscope 48 in the direction of light propagation, the camera 58 has an objective optical system 72 in the housing 60, which objective optical system images the image of the target area 16 transmitted by the endoscope 48 onto the image-recorder unit 62.

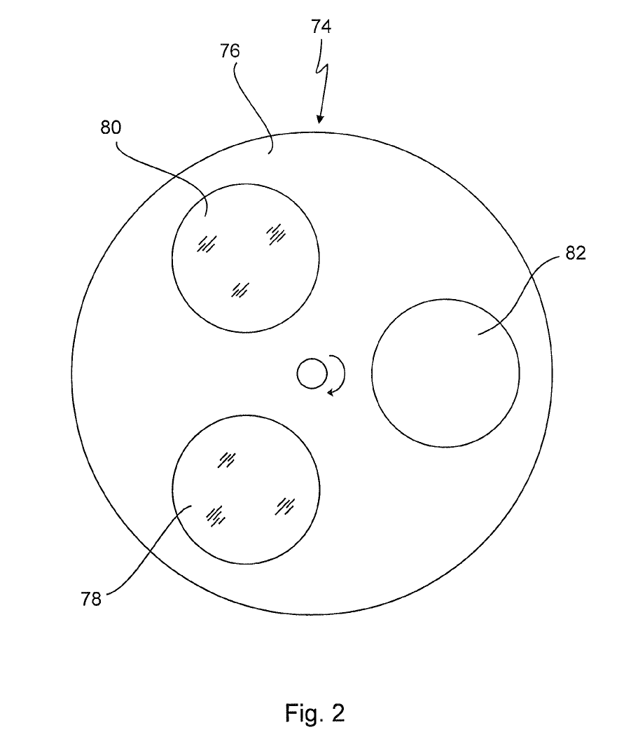

The camera 58 moreover has an optical arrangement 74, which is used to switch between a plurality of observation modes, which arc matched to the respectively set illumination mode. The optical arrangement 74 is additionally illustrated on its own in FIG. 2.

The optical arrangement 74 has an optical system changer 76, in this case a filter changer, which holds a plurality of optical elements 78, 80 and 82 (FIG. 2).

As was already described above with reference to the illumination system 12, two of the optical elements, for example the optical elements 78 and 80, are designed as spectral filters with differing spectral transmission characteristics, while the optical element 82 is designed as a light through-hole, which does not change the spectral properties of the light impinging on the optical element 82.

The optical system or filter changer 76 is designed as a wheel, which can rotate about an axis 84 as per an arrow 86, wherein the axis 84 runs parallel to the optical axis 88 of the observation beam path.

The optical arrangement 74, to be more precise the optical elements 78, 80 and 82, are arranged in the camera 58 in the region of the objective optical system 72, upstream of the image-recorder unit 62 in the direction of light propagalion. Here, the optical arrangement 74 with the optical elements 78, 80, 82 is arranged in particular substantially in the parallel beam path of the observation system 14, which, particularly in the case where at least one of the optical elements 78, 80 and 82 is a spectral filter in the form of an interference filter, has the advantage that the transmission characteristic of this spectral filter is not changed with respect to the specified specification of the spectral filter as a result of a divergent beam path.

The optical arrangement 74 of the observation system 14, which is integrated in the camera 58, has an electric-motor drive 90, which rotates the optical system changer 76 or the filter changer about the axis 84 in order respectively to introduce one of the optical elements 78, 80 or 82 into the observation beam path, or again to remove said element therefrom. The different observation modes, of which the observation system 14 has a total of three in the illustrated exemplary embodiment, are set thereby as a function of the respectively set illumination mode of the illumination system 12. Setting the desired observation mode does not involve a manual intervention by the user found in conventional apparatuses.

Instead of an electric-motor drive 90, magnetic, pneumatic, hydraulic, piezoelectric and electromagnetic drives can be used.

The electric voltage of the electric-motor drive can be supplied by the already available voltage supply (needed for e.g. the image-recorder unit 62) in the camera 58.

There is a control unit 92, for example a camera control unit, for bringing into the observation beam path the optical element 78, 80 or 82 respectively matching the set illumination mode of the illumination system 12, which control unit controls the electric-motor drive 90 as a function of the respectively set or current illumination mode of the illumination system 12 so that the electric-motor drive 90 changes the position of the optical system changer 76 such that the optical element 78, 80 or 82 matching the current illumination mode of the illumination system 12 is brought into the observation beam path.

For this, the control unit 92 is connected to the observation system 14, in this case the camera 58, and the illumination system 12, in this case the light source 18.

In the process, the control unit 92 particularly controls the electric-motor drive 90 synchronously with the change of the illumination mode of the illumination system 12 and the corresponding colour mode in the camera 58. For this, the control unit 92 has an integrated corresponding control program.

The control unit 92 is connected to the camera 58 and the light source 18 via a communication system 94, which is selected from the group having a field bus, Ethernet, Bluetooth, WLAN, USB or the like. In the present exemplary embodiment, the communication system 94 is an SCB® (STORZ Communication Bus) from the company Karl Storz GmbH & Co. KG, Tuttlingen, Germany.

In order to ensure correct matching of the respective observation mode to the current illumination mode, the optical arrangement 74 of the observation system 14 and/or the optical arrangement 24 of the illumination system 12 each have or has a position sensor (not illustrated) that detects the current configuration of the optical arrangement 74 of the observation system 14 and/or the current configuration of the optical arrangement 24 of the illumination system 12. Such a position sensor for example can detect the rotational position of the respective optical system changer 76 or 32 in respect of a reference rotational position.

The apparatus 10 furthermore has a monitor 96, on which the image of the target area 16 recorded by the camera 58 can be displayed.

In the following text, the functioning of the apparatus 10 is described.

The user uses an operating element 98 to set the desired operating mode of the apparatus 10. By way of example, the user in doing so can select between the following three operating modes: fluorescence mode I (fluorescence with a photosensitizer), fluorescence mode II (autofluorescence) and white-light mode.

For example, if the user selects fluorescence mode I, the control unit 92 synchronously controls the illumination system 12 and the observation system 14 in order, in the light source 18, to bring the optical element 26 or 28 belonging to the fluorescence mode I into the illumination beam path if there previously was a different rotational position of the optical system changer 32, and selects the corresponding colour mode of the camera. At the same time, the control unit 92 controls the electric-motor drive 90, which then, if necessary, rotates the optical system changer 76 in order to bring the optical element 78 or 80 matching the fluorescence mode I into the observation beam path. If the user subsequently wants to change from the fluorescence mode I into the fluorescence mode II, the user correspondingly actuates the operating element 98, whereupon the control unit 92 switches the illumination system 12 to the corresponding illumination mode fluorescence mode II and the observation system 14 to the corresponding observation mode fluorescence mode II, including the colour mode II in the camera control. In the process, the optical element 26 or 28 previously located in the illumination beam path is removed from the illumination beam path and the optical element 26 or 28 belonging to the desired illumination mode is introduced into the illumination beam path, and likewise, in the observation system 14, the optical element 78 or 80 previously located in the observation beam path is removed from the observation beam path and the optical element 78 or 80 matching the set illumination mode is brought into the observation beam path.

The same holds true if the user wishes to switch from the fluorescence mode II into the white-light mode, wherein, in that case, the optical elements 30 and 82 are brought into the respective beam path and the control unit 92 supplies the colour values for the standard white-light mode of the camera 58.

As a function of the operating mode selected by the user of the apparatus 10, the control unit 92 also sets the corresponding camera parameters of the camera, such as a white light balance, the integration time of the image recorders 64, 66 and 68, the brightness and the like and so the camera setting, in particular the colour values, are also matched to the desired and set illumination and observation mode of the apparatus 10 in an automatic fashion and without manual intervention by the user.

What is claimed is:

1. An apparatus for fluorescence diagnosis, comprising
an illumination system for illuminating a target area, said illumination system being switchable between at least two illumination modes,
an observation system for observing said target area, said observation system having
an observation instrument,
a camera,
an optical arrangement having at least one optical element that selectively can be introduced into an observation beam path or can be removed from said observation beam path in order to switch optical properties of said observation system between at least two observation modes,
said optical arrangement having a motor drive for introducing said at least one optical element into said observation beam path or for removing said element from said observation beam path,
a control unit connected to said illumination system and to said observation system, said control unit controlling said motor drive as a function of a set illumination mode of said illumination system.

2. The apparatus of claim 1, wherein said control unit sets an appropriate color mode of said camera as a function of said set illumination mode.

3. The apparatus of claim 1, wherein said control unit controls said motor drive synchronously with said set illumination mode of said illumination system.

4. The apparatus of claim 1, wherein said control unit controls a color mode of said camera synchronously with said set illumination mode of said illumination system.

5. The apparatus of claim 1, wherein said optical arrangement of said observation system is arranged in said camera.

6. The apparatus of claim 5, wherein said optical arrangement is arranged in a region of an objective system of said camera.

7. The apparatus of claim 1, wherein said at least one optical element is a spectral filter.

8. The apparatus of claim 1, wherein said optical arrangement is arranged substantially in a parallel beam path of said observation system.

9. The apparatus of claim 1, wherein said control unit sets camera parameters of said camera as a function of said set illumination mode.

10. The apparatus of claim 1, wherein said control unit sets camera parameters of said camera as a function of a set observation mode.

11. The apparatus of claim 1, wherein said control unit is connected to said observation system and said illumination system via a Communication system, which is selected from the group consisting of a field bus, Ethernet, Bluetooth, WLAN, USB.

12. The apparatus of claim 1, wherein said optical arrangement of said observation system has a motor-driven optical system changer which has said at least one optical element.

13. The apparatus of claim 12, wherein said optical system changer is a filter changer.

14. The apparatus of claim 12, wherein said optical system changer is designed as a wheel that can be rotated about an axis parallel to an optical axis of said optical arrangement.

15. The apparatus of claim 1, wherein said at least two illumination modes of said illumination system comprise a white-light mode and at least one fluorescence-excitation mode.

16. The apparatus of claim 12, wherein said optical system changer as a plurality of optical elements which have a plurality of spectral filters for a plurality of spectral ranges.

17. The apparatus of claim 1, wherein said illumination system has a second optical arrangement having at least one optical element that selectively can be introduced into an illumination beam path of said illumination system or can be removed from said illumination beam path in order to switch between said at least two illumination modes.

18. The apparatus of claim 1, wherein said optical arrangement of said observation system has a sensor that detects a current configuration of said optical arrangement of said observation system.

19. The apparatus of claim 17, wherein said second optical arrangement of said illumination system has a sensor that detects a current configuration of said second optical arrangement of said illumination system.
